(19) United States
(12) Patent Application Publication
(10) Pub. No.: US 2012/0299931 A1
(43) Pub. Date: Nov. 29, 2012

(54) DRAWING GUIDANCE AND STYLUS

(75) Inventor: Daniel Owen Monahan, Carlsbad, CA (US)

(73) Assignee: DANO2, LLC, Carlsbad, CA (US)

(21) Appl. No.: 13/481,570

(22) Filed: May 25, 2012

Related U.S. Application Data
(60) Provisional application No. 61/519,680, filed on May 27, 2011.

(51) Int. Cl. G06F 3/033; G06F 3/041; G06T 11/20

(52) U.S. Cl. 345/441; 345/179; 345/173

(57) ABSTRACT

A computer program includes processor-readable instructions configured to cause a processor to: display to a user an object with initial visual stroke guidance information prompting the user to draw an initial stroke for drawing the object, the initial visual stroke guidance information including an indication of a starting location for an initial stroke and an indication of a direction indicator of the initial stroke from the starting location, the visual stroke guidance being configured to prompt the user to draw on the display at a present prompted location; analyze data from the display regarding contact with the display by the user; and in response to determining that the data indicate contact with the display by the user at the present prompted location, provide visual feedback indicating progress in drawing the stroke and change the present prompted location to a different location on the display.

### CROSS-REFERENCE TO RELATED APPLICATIONS

This application claims the benefit of U.S. Provisional Application No. 61/519,680, filed May 27, 2011, entitled “System For Children Fun learning and Ancillary Products.”

### BACKGROUND

Children increasingly use electronic devices for a variety of activities. For example, children play electronic games, research subjects, read books, and communicate with family and/or friends using electronic devices.

For educational purposes, software applications often provide electronic versions of well-known materials. For example, applications provide mathematical problems or other known educational activities in electronic form such that the activities can be easily erased and repeated without using paper or expending a single-use tool requiring re-purchase of the educational tool. Schools are increasingly using electronic devices for educational purposes, e.g., providing or allowing calculators and even providing tablet computers to students.

Electronic devices come in a variety of forms and can be used in a variety of manners. For example, users can interact with a desktop or a laptop computer using a mouse, a keyboard, or a microphone. Users can interact with mobile phones, e.g., smart phones, using a physical keyboard, a microphone, or a touchscreen. For touchscreen interaction, the user may use a portion of the user's body, e.g., a fingertip, or a tool such as a stylus. Styli come in a variety of sizes, but are generally thin, cylindrical, and hard.

### SUMMARY

An example of a computer program product residing on a processor-readable storage medium includes processor-readable instructions configured to cause a processor to: cause a display to display to a user an object with initial visual stroke guidance information prompting the user to draw an initial stroke for drawing the object, the initial visual stroke guidance information including an indication of a starting location for an initial stroke and an indication of a direction indicator of the initial stroke from the starting location, the visual stroke guidance being configured to prompt the user to draw on the display at a present prompted location; analyze data from the display regarding contact with the display by the user; and in response to determining that the data indicate contact with the display by the user at the present prompted location, cause the display to provide visual feedback indicating progress in drawing the stroke and to change the present prompted location to a different location on the display.

Implementations of such a computer program product may include one or more of the following features. The instructions are further configured to cause the processor to cause the display to display a complete initial stroke line indicating the complete initial stroke, and initially to display only the initial stroke from among a multiple strokes for completing the object. The instructions are further configured to cause the processor to cause the display to display a second stroke line for a second stroke for drawing the object only in response to determining that the data indicate successful complete drawing of the initial stroke. The instructions are configured to cause the processor to cause the display to display the direction indicator in proximity to and pointing toward the present prompted location. The instructions are configured to cause the processor to cause the display to display a set of objects, including the object, and an indication of successful completion of drawing for each of the objects.

An example of a stylus includes: a body including: a proximal end; a grasping portion extending distally from the proximal end, having a triangular cross-section, and including at least one first conductive portion; and a distal end extending from the grasping portion and including a tip with a second conductive portion conductively coupled with the at least one first conductive portion of the grasping portion.

Implementations of such a stylus may include one or more of the following features. The cross-section of the grasping portion has equal length sides of at least about 0.3 inches. The grasping portion is configured to provide visual indications of preferred locations for a user to grasp the stylus. The at least one first conductive portion includes first conductive portions that appear differently from other portions of the grasping portion. The first conductive portions have a different color than the other portions of the grasping portion. The tip is configured to interact with a touchscreen to simulate interaction of a pencil with paper. The tip is rounded and hollow, being configured to deform to provide a flat section of at least about 0.18 inches in diameter in response to being pressed against a flat surface with about 0.1 pounds of force. The stylus further includes: a frequency generator; a speaker communicatively coupled to the frequency generator; and a selector coupled to the frequency generator; where the frequency generator is configured to respond to actuation of the selector to cause the speaker to emit an audio signal with a frequency at or above about a human hearing range.

An example of a system includes: a computer program product residing on a processor-readable storage medium and including processor-readable instructions configured to cause a processor to: cause a display to display to a user an object with initial visual stroke guidance information prompting the user to draw an initial stroke for drawing the object, the initial visual stroke guidance information including a complete initial stroke line, an indicator of a starting location for the initial stroke and an indication of a direction of the initial stroke from the starting location, the visual stroke guidance being configured to prompt the user to draw on the display at a present prompted location; analyze data from the display regarding contact with the display by the user; in response to determining that the data indicate contact with the display by the user at the present prompted location, cause the display to provide visual feedback indicating progress in drawing the stroke and to change the present prompted location to a different location on the display; and cause the display to display a second stroke line for a second stroke for drawing the object only in response to determining that the data indicate successful complete drawing of the initial stroke; and a stylus including: a proximal end; a grasping portion extending distally from the proximal end, having a triangular cross-section, and including first conductive portions having an appearance that is different from an appearance of other portions of the grasping portion; and a distal end including a tip with a second conductive portion conductively coupled with the first conductive portions of the grasping portion.

Implementations of such a system may include one or more of the following features. The stylus further includes: a frequency generator; a speaker communicatively coupled to the frequency generator; and a selector coupled to the frequency generator; where the frequency generator is configured to respond to actuation of the selector to cause the speaker to emit an audio signal with a frequency at or above about a human hearing range; and where the instructions are further configured to cause the processor to respond to signals received from a receiver in response to the audio signal to change at least one characteristic of a visual response on the display to contact by the stylus with the display. The at least one characteristic is at least one of color, stroke width, and stroke edge smoothness.

Items and/or techniques described herein may provide one or more of the following capabilities, as well as other capabilities not mentioned. Users can be trained to write while using an electronic device. A stylus can provide guidance as to proper grip location, help with grip form, and interact with an application to provide guidance as to grip pressure. Guidance can be provided for preferred techniques for drawing objects including preferred stroke order/sequence, and for each stroke, preferred start, end, and direction, for drawing letters or numbers. Writing with a stylus on a touchscreen can simulate writing with a pen or pencil on paper. Further, it may be possible for an effect noted above to be achieved by means other than that noted, and a noted item/technique may not necessarily yield the noted effect.

### BRIEF DESCRIPTION OF THE DRAWINGS

FIG. 1 is perspective view of an object drawing system.

FIG. 2 is a block diagram of components of an electronic device shown in FIG. 1.

FIG. 3 is a block flow diagram of a drawing guidance process.

FIGS. 4-8 are simplified screenshots of a display of the electronic device shown in FIG. 1 showing stages of the drawing process shown in FIG. 3 for a first object.

FIG. 9 is a simplified screenshot of the display of the electronic device shown in FIG. 1 showing an options menu and a progress screen.

FIG. 10 is a simplified screenshot of the display of the electronic device shown in FIG. 1 showing drawing guidance for a second object.

FIG. 11 is a simplified screenshot of the display of the electronic device shown in FIG. 1 showing an alternative mode of drawing guidance for the second object.

FIG. 12 is a perspective view of a stylus shown in FIG. 1.

FIG. 13 is a cross-sectional view of the stylus shown in FIG. 12.

FIG. 14 is cross-sectional view of a portion of the stylus shown in FIG. 12 while in contact with the display shown in FIG. 1.

FIG. 15 is a block diagram of components of stylus shown in FIG. 12.

### DETAILED DESCRIPTION

Techniques are discussed herein for assisting users to draw shapes. For example, a child learning to write can be assisted with learning to draw characters such as letters and numbers. The child can be presented with an electronic representation of the desired character and an indication of a preferred first stroke, including shape, starting point, and direction of the stroke. Positive feedback is provided for correct performance of the stroke and no or negative feedback provided for deviations from the correct performance of the stroke. If more than one stroke is to be used for the character, then successful completion of the first stroke results in prompting the user for a second stroke, again with guidance as to shape, starting point, and direction of the stroke.

Further, examples of styli are provided for assisting users to draw the shapes and to learn to use a stylus to draw the shapes. For example, a stylus is provided that is sized for a child to comfortably grasp the stylus. The stylus has a triangular cross-section to help train the child to hold writing implements, such as pens and pencils, in a proper or at least a preferred manner for writing. Further, the stylus is shaped and made of materials such that interaction of a tip of the stylus with a touchscreen simulates interaction of a pen and paper or a pencil and paper.

These examples, however, are not exhaustive.

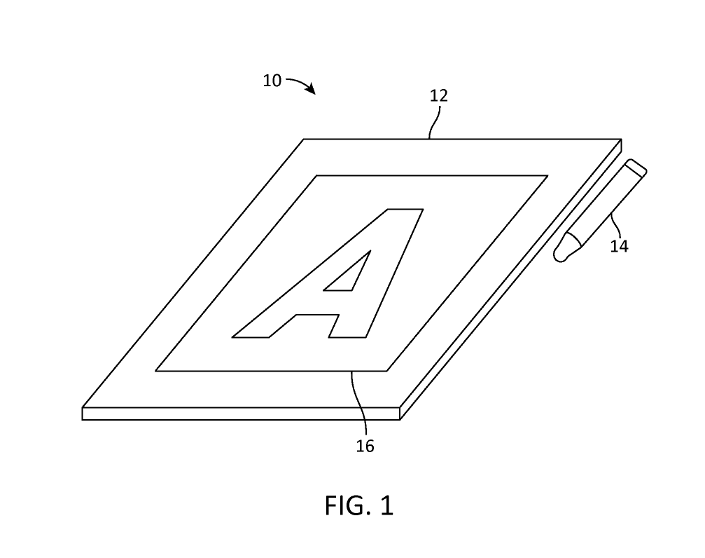

Referring to FIG. 1, an object drawing training system 10 includes an electronic device 12 and a stylus 14. The device 12, e.g., a computer such as a tablet computer, a personal digital assistant or the like, includes a display 16 for providing visual prompts to a user of the device. Here, as more fully discussed below, the device 10 provides character, e.g., letter or number, writing training via the touchscreen display 16. The stylus 14 is configured to interact with the display 16 to provide input to a training program in the device 12, and is configured to interact with the display 16 to simulate writing on paper with a pen or pencil.

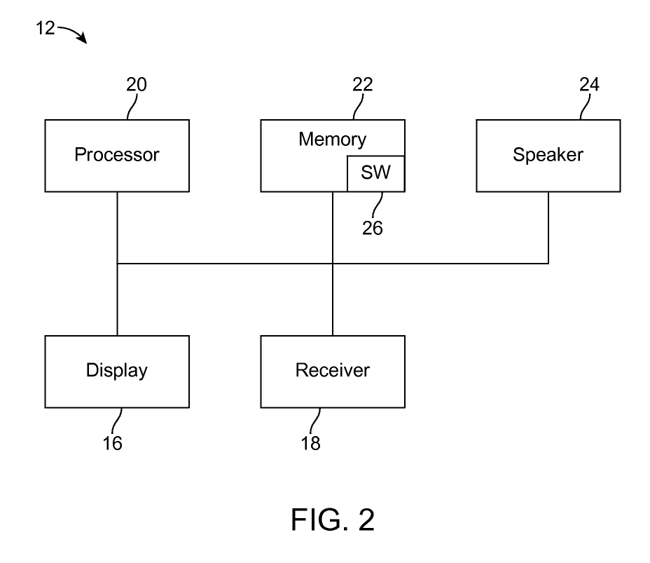

Referring also to FIG. 2, the device 12 comprises a computer system including the display 16, a receiver 18, a processor 20, non-transitory memory 22, and a speaker 24. The receiver 18 is configured to receive sound signals, transduce these signals into electrical signals, and provide the electrical signals to the processor 20. The processor 20 is preferably an intelligent device, e.g., a personal computer central processing unit (CPU) such as those made by Intel® Corporation or AMD®, a microcontroller, an application specific integrated circuit (ASIC), etc. The memory 22 is a computer-readable storage medium and includes random access memory (RAM) and read-only memory (ROM). The display 16 is a liquid-crystal display (LCD) (e.g., a thin-film transistor (TFT) display) touch-sensitive screen configured to accept touches as data input. The speaker 24 is configured to provide audible output such as voice or other sounds, examples of which are discussed below. The device 12 stores, e.g., in the memory 22, processor-readable, processor-executable software code 26 containing instructions for controlling the processor 20 to perform functions described herein (although the description may read that the software 26 performs the function(s), or that the processor 20 performs the functions without reference to the software 26). The processor 20 and the software 26 together form a processing module. The functions implement an object drawing training system. The software 26 can be loaded onto the memory 22 by being downloaded via a network connection, uploaded from a disk, etc. Further, the software 26 may not be directly executable, e.g., requiring compiling before execution.

Drawing Application

Here, the software 26 implements a drawing application including drawing guidance. The application provides for several options regarding what objects the application assists the user to learn to draw, how detailed of guidance the application provides, progress reports as to what objects have been successfully drawn, and information about the objects provided for drawing. For example, the software 26 provides objects in either a stroke mode or a challenge mode. In the stroke mode, an object is displayed with visual indication and/or audible indications as to strokes for drawing the object. The strokes, if there are more than one to draw an object, are presented in sequence of preferred or desired order for drawing the object. Further, for each stroke, the indication(s) provide assistance to the user as to a preferred start point, a preferred end point, and a preferred path, including preferred direction, of the stroke. While objects may be drawn in numerous different ways, the stroke guidance provides preferred manners for individual strokes and preferred sequences of strokes, to assist users with learning preferred techniques for objects. For example, these preferred techniques may help users draw objects consistently, quickly, with proper appearance, with proper spacing relative to other objects (e.g., letters), and/or with other desired or advantageous characteristics and/or effects.

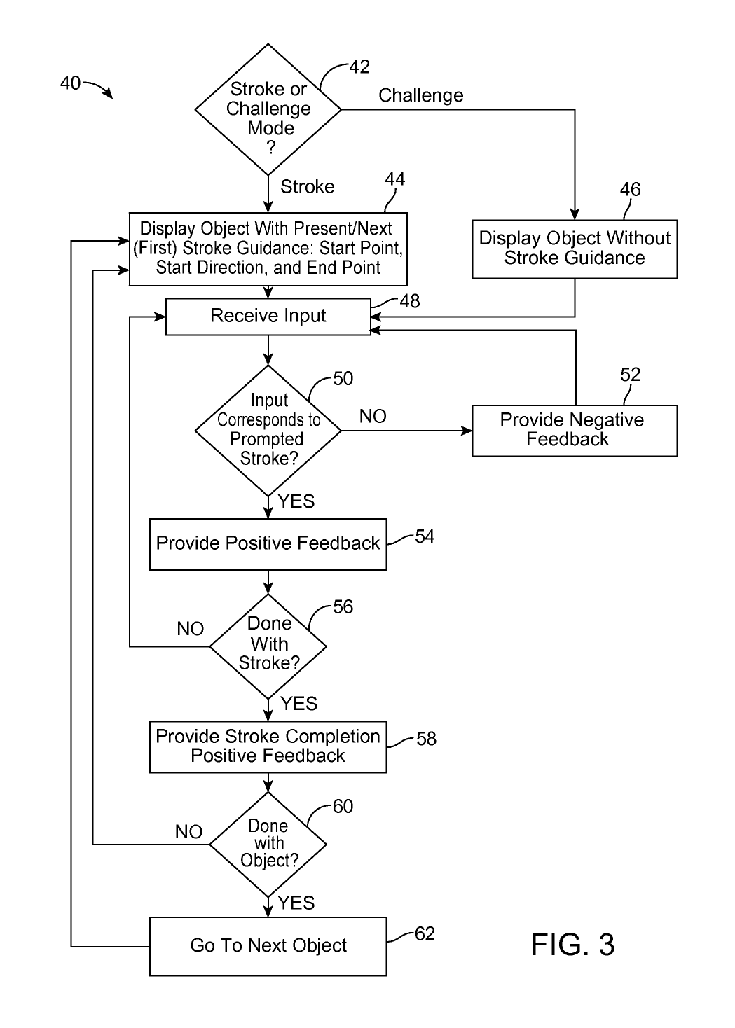

Referring to FIG. 3, with further reference to FIGS. 1-2 and FIGS. 4-8, a process 40 of guiding a user through drawing an object includes the stages shown. The process 40 is, however, an example only and not limiting. The process 40 can be altered, e.g., by having stages added, removed, rearranged, combined, and/or performed concurrently. For example, stages 52 and/or 58 discussed below could be removed.

At stage 42, a determination is made as to whether the drawing guidance application is in the visual stroke mode or the visual challenge mode. The processor 20 responds to the application being initiated by determining the present mode. If the present mode is the stroke mode, then the process 40 proceeds to stage 44. If the present mode is the challenge mode, then the process 40 proceeds to stage 46, where the processor 20 displays the object without visual or audio guidance, e.g., as shown in FIG. 11 below.

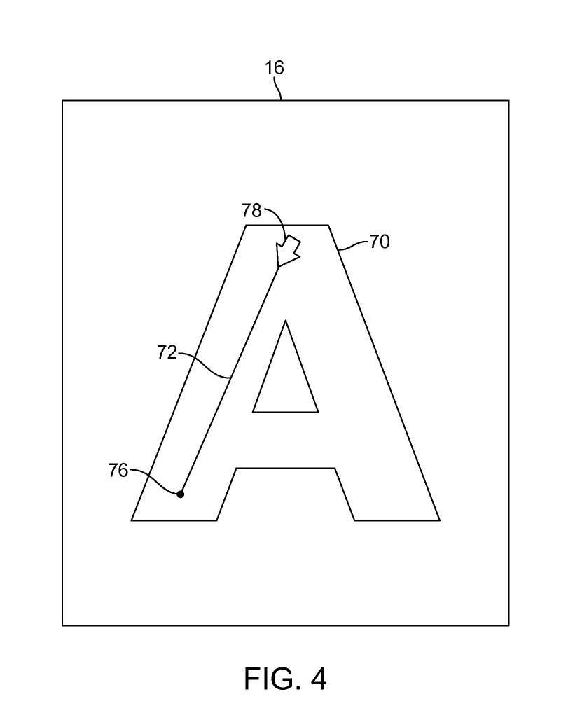

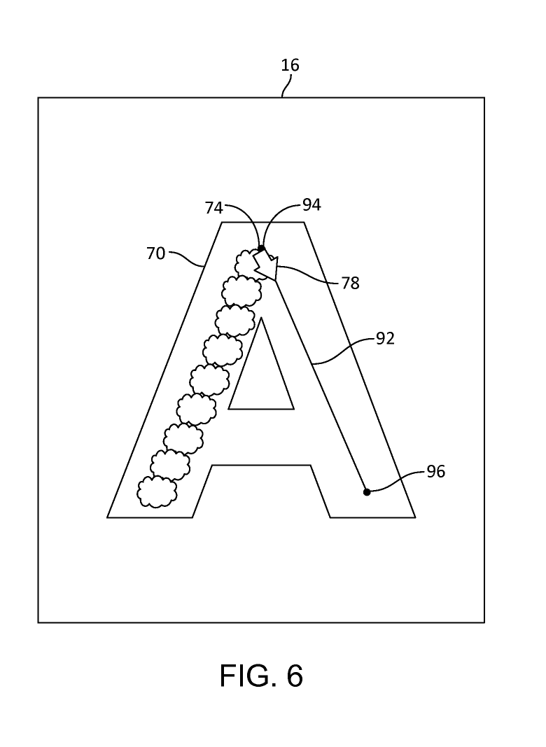

At stage 44, with the drawing guidance application in the stroke mode, the processor 20 displays an object 70 and provides visual stroke guidance for the present/next stroke. Initially, as shown in FIG. 4, the object 70 has no indication of drawing progress and the present/next stroke is the initial or first stroke for the object 70. As shown, the object 70 preferably has a thickness, being outlined with an empty interior 71, prompting the user to draw in the interior of the object 70. While in this example, the processor 20 does not provide audio guidance through the speaker 24, in other examples, the processor 20 can provide such guidance, such as speech to instruct the user where to begin a stroke and in what direction to draw the stroke. In this example, the visual stroke guidance includes a line 72, a start point 74 (see FIG. 6), an end point 76, and a direction indicator 78. Initially, preferably the only stroke indicator line displayed is the line 72, with lines for subsequent strokes not being displayed. For subsequent strokes, the present stroke is displayed differently than completed strokes. For example, completed stroke lines may be obscured or otherwise not visible to the user and only the present stroke line, or uncompleted portion thereof, is displayed for the user. While here the indicator 78 is an arrow, other configurations are possible, such as an airplane or other item that indicates direction. Further, the indicator 78 could be multiple icons, e.g., an airplane and runway lights disposed in front of the airplane and along and/or near (or instead of) the line 72.

The guidance provides the user with structural and directional guidance to draw the first stroke toward drawing the object 70. The visual guidance indicates the complete shape of the stroke, the preferred beginning of the stroke, i.e., the start point 74 and the direction indicated by the direction indicator 78, and the preferred ending of the stroke, i.e., the end point 76. The arrow 78 serves a dual role as (1) an ongoing or persistent directional prompt to indicate correct direction from the present stroke progress for continued stroke drawing and (2) an indication of progress of correct stroke drawing and present location for correct drawing input. Thus, the indicator can be a direction and progress indicator. The indicator 78 serves these roles by moving in response to the input to be at the position of last correct stroke input and pointing to the location of the next correct stroke input along the line 72.

Preferably, the stroke guidance is provided for the present stroke and not future strokes. Because in this example, for a capital “A,” there is more than one preferred stroke to draw the object 20, the visual guidance shown in FIG. 4 is for a first stroke and portions of the object 70 to be drawn with future strokes are left blank. Thus, only the current, here first, stroke is displayed for the user which may help the user learn to draw the object 70, avoiding confusion, and teaching sequence of the drawing.

At stage 48, the processor 20 receives input regarding the drawing of the object 70. The user provides the input by touching the display 16, preferably with the stylus, to attempt to draw the prompted-for portion of the object 16, i.e., to attempt to replicate the indicated preferred stroke. The input may be contact by the stylus with the display 16 in any portion of the display 16.

At stage 50, an inquiry is made as to whether the input corresponds to the prompted-for stroke and thus is acceptable. The processor 20 determines whether the stylus contacts the display 16 within an acceptable range of a desired part of the line 72 and within the outline of the object 70, with the desired spot moving as progress drawing the stroke is made. This desired spot is a preferred current sequential portion of the line 72, i.e., initially at the prompted direction indicator 78, and then a next portion of the line 72 in the desired direction if the start point 74 has already been contacted (thus constituting a desired sequence of portions of the line 72). If the input does not correspond to the prompted-for stroke, e.g., the input indicates contact with the display 16 in a location other than a preferred current sequential portion of the line 72, then the process 40 proceeds to stage 52. If the input does correspond to the prompted-for stroke, i.e., the input indicates contact with the display 16 in a location other than a preferred current sequential portion of the line 72, then the input is unacceptable and the process 40 proceeds to stage 54.

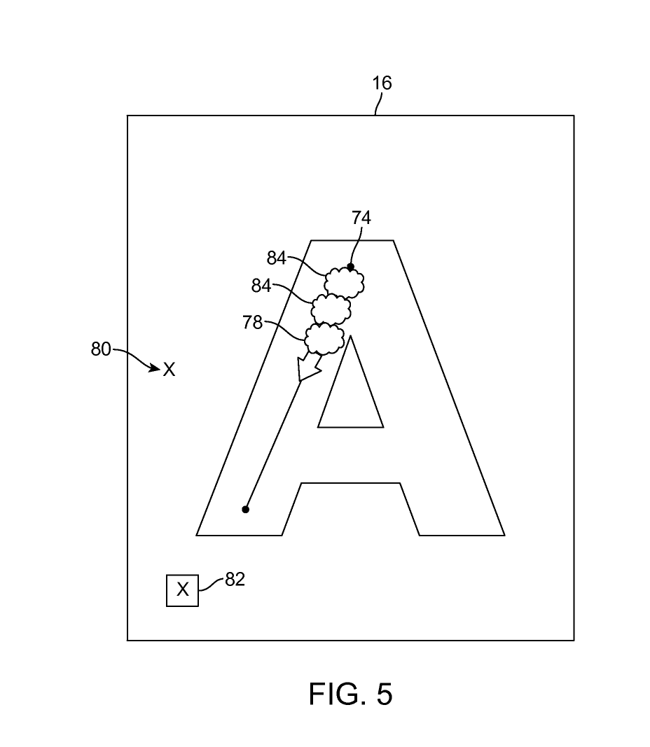

At stage 52, the processor 20 provides negative feedback to the user. The feedback is real-time (e.g., within 200 milliseconds or even within 10 milliseconds) and can take various forms such as a visual indication, e.g., a red “X” 80 (FIG. 5) on the portion of the display 16 contacted by the stylus or elsewhere in a fixed position, e.g., an error window 82, on the display 16. Alternatively, a different or additional prompt could be provided such as a red dot on the preferred current sequential portion of the line 72 or a change in a color of the preferred current sequential portion of the line 72, e.g., from white to green or yellow. The feedback could also, or alternatively, be an audio indication such as “incorrect,” a buzzer sound, and/or a prompt for correct input such as “touch the yellow portion of the line next.” Alternatively, no negative feedback may be provided so as not to discourage a user, such as a child, from attempting to draw the object 70. In this case, stage 52 may be omitted. After the feedback, during the feedback, or in the absence of stage 52, the process 40 returns to stage 48 for further input.

At stage 54, the processor 20 provides positive feedback to the user regarding the successful input toward completing the stroke. The feedback could be to show a path of contact with the display 16, e.g., by changing color(s) of pixels contacted by the stylus 14, but is preferably shown as progress along the line 72 even if the exact path drawn by the user deviates from the line 72. The feedback is preferably in real-time and may take a variety of forms such as smoke puffs 84 (FIG. 5) indicating a smoke trail (e.g., of a racecar or an airplane), a changing of color of the line 72 (e.g., from white to green), an audible sound such as “keep going,” or “you're doing great,” a pleasant-sounding tone, etc., or a combination of any of these indications. Visual feedback is preferably persistent during the present stroke and during future strokes, if any, e.g., so that the user can tell what has already been accomplished and that correctly-performed portions do not need to be repeated.

At stage 56, the processor 20 determines whether the stroke has been successfully completed. If not, then the process 40 returns to stage 48 for more input, and if so, then the process 40 proceeds to stage 58.

At stage 58, the processor 20 provides stroke completion success feedback. The processor 20 provides stroke-completion positive feedback such as a pleasant-sounding tone, a check mark next to or on the completed stroke, etc. Alternatively, stage 58 could be omitted.

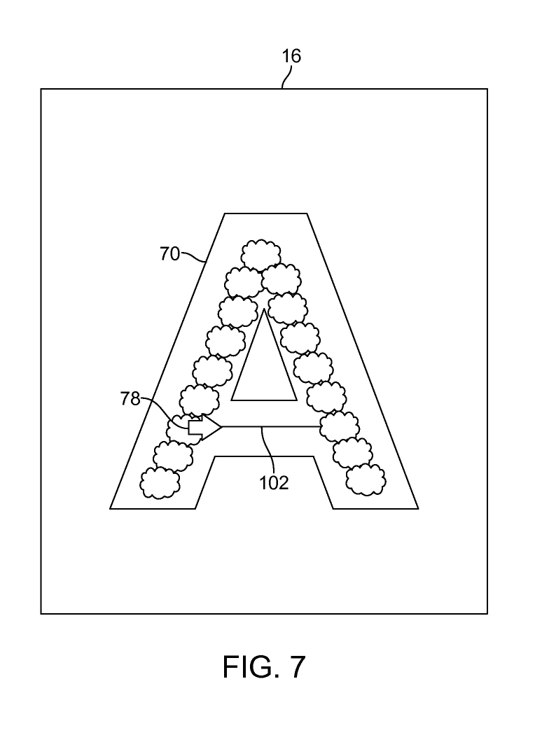

At stage 60, a determination is made as to whether the user is done drawing the object 70. The processor 20 determines whether all strokes for drawing the object 70 have been performed. If not, then the process 40 returns to stage 44 where the next stroke is displayed for the user, including a new visual indication of the next stroke. For example, as shown in FIG. 6, a line 92 is provided with a start point 94 (FIG. 7), that corresponds to the start point 74, and an end point 96. The direction indicator 78 is at the start point 94 and pointing along the line 92 in the preferred (acceptable) stroke direction. Similarly, when the stroke 92 is completed, a next stroke 102 is displayed (FIG. 7). If at stage 60 the processor 20 determines that all strokes for the object 70 have been completed, then the process 40 proceeds to stage 62.

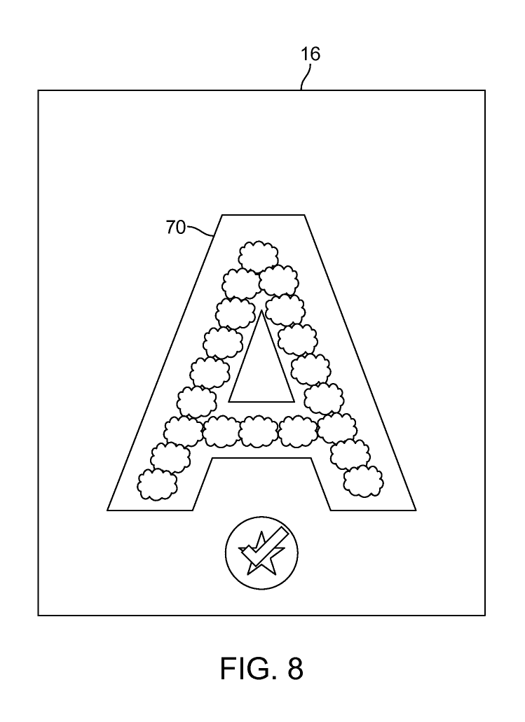

At stage 62, the processor 20 indicates object completion and changes the present object to a next sequential object from a list of available objects. The processor 20 indicates object completion by displaying (via the display 16) a completion indication or icon 86 (FIG. 8), here a star with a check mark. The processor 20 displays the completed object, with full visual positive stroke completion feedback 84 for a short time, e.g., 1-2 seconds, and then selects a next object in a present set of objects. In this example of an alphabet, with the object 70 being a capital “A,” the next object in the set will be a capital “B” if the set is the alphabet and the sequence is the order of the alphabet. Other sequences could be used, e.g., with objects using similar strokes being grouped together. For example, after a capital “B,” the next object could be a capital “D” if letters with similar first strokes are grouped together in the sequence. With a next object selected, the process 40 returns to stage 44 for display of the next object with an initial stroke displayed.

Alternatively, stage 62 could be a determination as to whether all objects in a sequence have been completed. For example, the processor 20 could determine whether all capital (upper-case) letters have been completed, all lower-case letters have been completed, all upper-case and lower-case letters have been completed, or whether some other amount of objects have been completed. If not, then the processor 20 could select the next object and the process could return to stage 44. If the processor 20 determines that all objects in the desired set have been completed, then the process could proceed to a stage where the processor 20 indicates successful completion of the set, e.g., by displaying the entire set in reduced form with an indication of set completion and/or individual completion indications for each object. The process could then end.

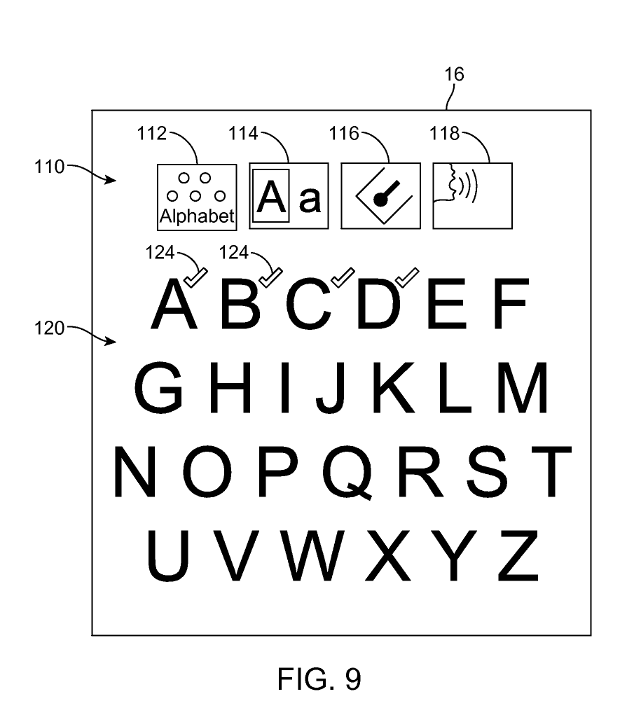

Referring to FIG. 9, with further reference to FIG. 2, the processor 20 provides a menu bar 110 as part of the drawing guidance application. The menu bar 110 includes a set progress selector 112, a drawing mode selector 114, a visual guidance mode selector 116, and an audio information/feedback mode selector 118.

The processor 20 is configured to respond to selection of the set progress selector 112 by displaying a set indication 120 showing members 122 (objects) of the presently-selected object set. The set indication 120 includes completion indicators 124, here check marks, that the processor 20 is configured to display for each of the objects 122 that have been successfully drawn to indicate such successful drawing. The processor 20 is configured to respond to selection of any of the objects 122 by changing the present object to the selected object and initiating the process 40 for the present object.

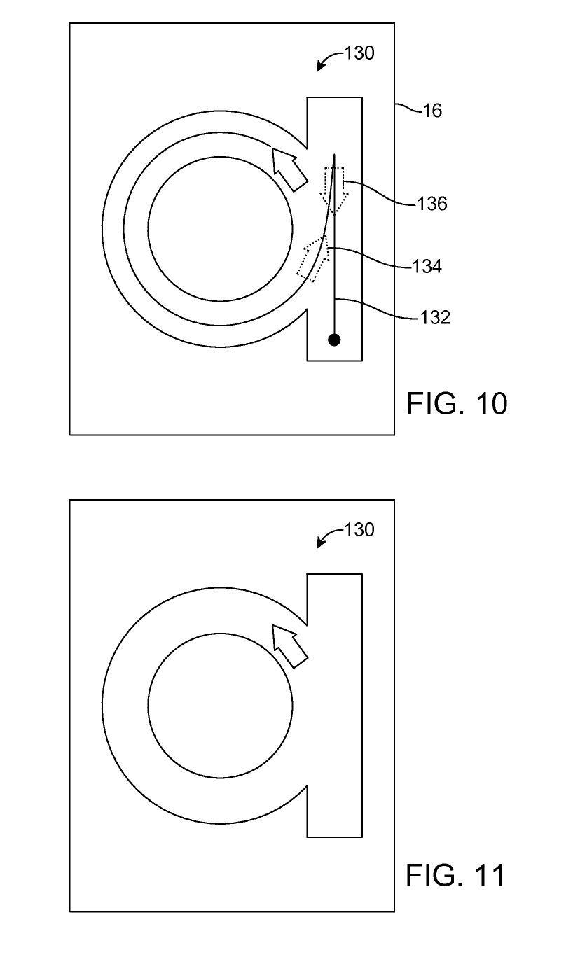

Referring also to FIG. 10, the processor 20 is configured to respond to selection of the drawing mode selector 114 by changing the present drawing mode. For example, the drawing modes may include free-style drawing, and/or various object set modes. For example, the processor 20 can respond to actuation of the selector 114 to change from one set of available objects to another set of available object sets and to initiate the process 40 for the selected set. In this example, actuation of the selector 114, e.g., by touching the selector icon 114 with the stylus 14 (FIG. 1), causes the processor 20 to toggle between object sets of upper-case letters and lower-case letters. In this example, the processor 20 changes from the upper-case letter set to the lower-case letter set and displays the first object of the lower-case set, here an object 130 that is a lower-case “a.” The processor displays the drawing guidance per stage 44 of FIG. 3, here a single line 132, with the starting point of the direction indicator 78 being near a top, middle portion of the object 130. As indicated by dashed-line indicators 134, 136, in response to proper input from the user of a first portion of the stroke 130, the processor 20 will quickly change the direction indicated by the direction indicator 78 near a vertex 138 from upward and to the right, to downward.

Referring also to FIG. 11, the processor 20 is configured to respond to selection of the mode selector 116 by displaying an object without the directional guidance. Here, the processor 20 displays the object 130, a lower-case “a,” without the guidance line 132 shown in FIG. 10. The processor 20 does, however, display the direction indicator 78. Further, the processor will display positive feedback (e.g., the indicators 84 (FIGS. 5-8) for correct drawing input of the object 132. Alternatively, e.g., in other modes, either the indicator 78 or positive feedback before completion of drawing of the object 130 may not be displayed by the processor 20, but preferably the processor 20 will still display feedback for successful completion of drawing of the object 130.

The processor 20 is configured to respond to selection of the audio information/feedback selector 118 by implementing one or more audio modes. For example, the processor 20 may respond by toggling between audio ON and audio OFF modes. In the audio ON mode, the processor 20 may provide various audio information regarding an object. For example, the processor 20 may play audio through the speaker 24 indicating a sound or sounds made by the present letter (i.e., phonics), a word or words that begin with the present letter (i.e., use), a sentence using this word or these words (i.e., use). The audio provided may be in the form of and/or include appropriate humor, e.g., age-appropriate humor for persons that would be learning to write letters and numbers. For example, for the letter “d” the audio may be “d says ‘duh’ as in ‘dog’ or ‘dinosaur.’ People sometimes take their dog on a plane, but they never take their dinosaur.” The audio may also provide object completion feedback, e.g., “That is one good-looking letter.” Alternatively, the processor 20 may respond by cycling through modes with different sets of these features being ON, e.g., with one mode having only the only letter sound on, another mode having only the letter sound and the sentence on, another mode having the letter sound, sentence, and completion feedback on, another mode having only the letter sound and the completion feedback on, etc.

Stylus

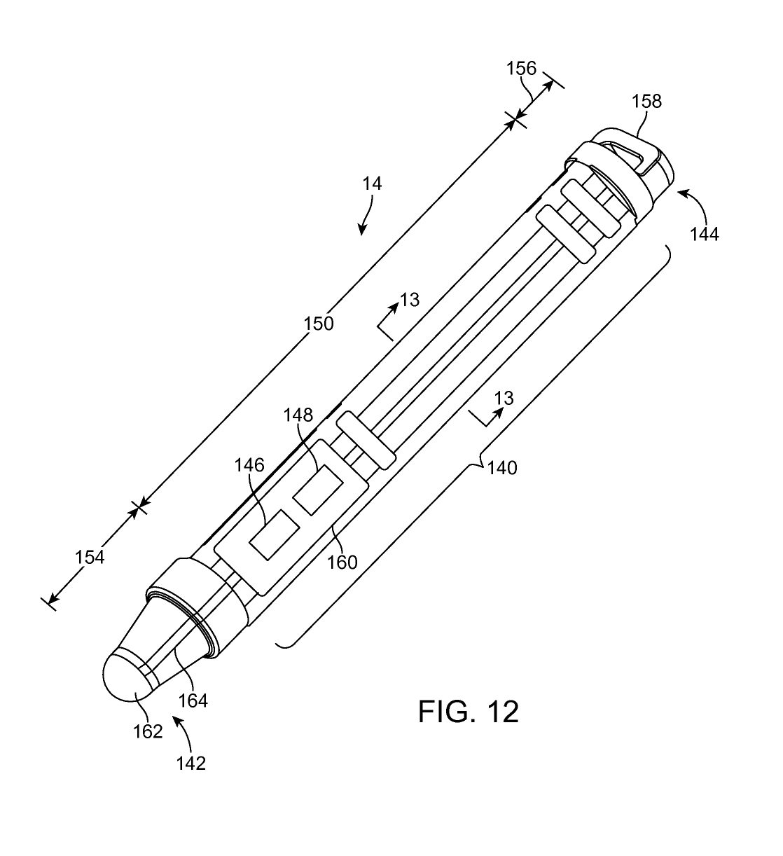

Referring to FIG. 12, with further reference to FIG. 1, the stylus 14 has a body that includes a main or grasping portion 140, a proximal end 142, and a distal end 144. The grasping portion includes a color selector button 146 and a style selector button 148.

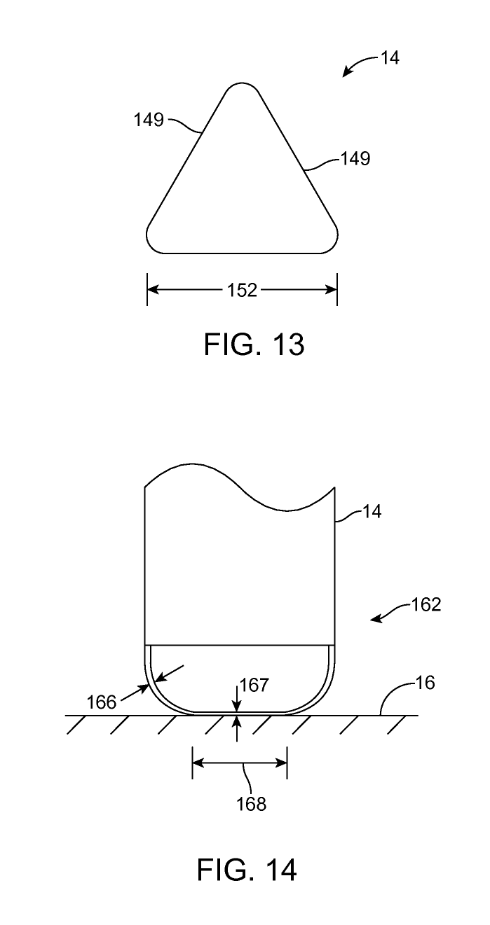

The stylus is configured in both size and shape to help train a person where and how to hold a writing implement. The body 140 is configured to fit and be easily grasped by a hand of a child of a typical age for a child learning to write, e.g., three to seven years old. For example, the grasping portion 140 of stylus has a length 150 of about 3.25 inches long and, referring also to FIG. 13, has a triangular-shaped cross-section, preferably of an equilateral-triangle-shaped cross-section with rounded corners and equal-length sides 149 of length 152 of at least about 0.3 inches, more preferably at least about 0.4 inches, and here about half an inch. The proximal end 142 has a length 154 of about ⅞ of an inch, and the distal end 144 has a length 156 of about ⅜ of an inch.

The stylus includes conductive material to make the stylus capacitive to facilitate interaction with touchscreens. The body 140 includes a finger pad 160 on each of the sides 149 disposed at locations of preferred contact by the user when properly holding the implement, and sized to help ensure contact by the user's fingers. The pads 160 are made of conductive material such as conductive silicone while other portions of the body 140 are made of non-conductive material. The conductive material preferably has a surface resistivity between about 10⁶ ohms/square and about 10⁻⁶ ohms/square. The conductive material may include carbon black powder and/or carbon fiber. The pads 160 have an appearance that is different from other portions of the grasping portion 140, e.g., a different color and/or texture, to prompt or guide the user to grasp the stylus 14 at preferred locations. At least one of the pads 160 is electrically coupled to a tip 162 of the proximal end 142, with the tip 162 being conductive, e.g., of the same material as the pads 160. This may further prompt the user to grasp the stylus 14 using the pads 160 by inhibiting effectiveness of the stylus 14 if the user does not grasp the stylus 14 using at least one of the pads 160. As shown in FIG. 12, the tip 162 is connected to the pad 160 with a strip 164 of the same conductive material as that forming the pad 160 and the tip 162. The strip 164 preferably extends the length of the grasping portion 140 to help ensure contact with the user. The conductive pads 160 are preferably of a different color than other portions of the stylus 14 to provide visual guidance to the user as to where to grasp the stylus.

The stylus 14 is configured to mimic the feel of writing with a pen and paper or a pencil and paper when the stylus is used with a touchscreen. The tip 162 has a low-friction coating, here a TEFLON® coating, to facilitate movement of the tip 162 across a surface of the display 16. For example, the tip 162 may have a coefficient of static friction of about 0.05-0.10. The tip 162 has rounded or domelike shape. Further, referring also to FIG. 14, the tip 162 is partially hollow, having a tapered wall thickness with a wall thickness 166 of about 1 mm on the side and a wall thickness 167 of about 0.5 mm on the end. The tip 162 is configured to deform to provide a flat surface in contact with the display 16 with a diameter 168 of at least about 0.18 in. when the tip 162 is pushed against the display 16 with a preferred amount of force for writing with a pen or pencil, e.g., about 0.1 pounds.

The stylus 14 is configured for portability and to simulate other writing utensils such as pens and pencils. The implement is light, easily carried, and the end 144 provides a loop 158 configured to receive a lanyard. Further, the body 140 includes a stiffener, e.g., a metal rod (although other materials could be used), to provide rigidity to simulate the rigidity of other writing utensils.

The stylus 14 is configured for multiple uses, including medical applications. The size and shape of the body 140, in addition to facilitating grasping by children, also facilitates grasping by adults wearing gloves such as surgical gloves.

The stylus 14 is easily assembled. The conductive material is assembled over the stiffener and the remaining, non-conductive material, is molded over portions of the conductive material. The stylus is constructed and the outer materials of the stylus 14 are selected to be safe if placed in a person's mouth. Also or alternatively, the stylus may be constructed and the outer materials selected such that the stylus could be sterilized in an autoclave.

Interaction Between Stylus and Drawing Application

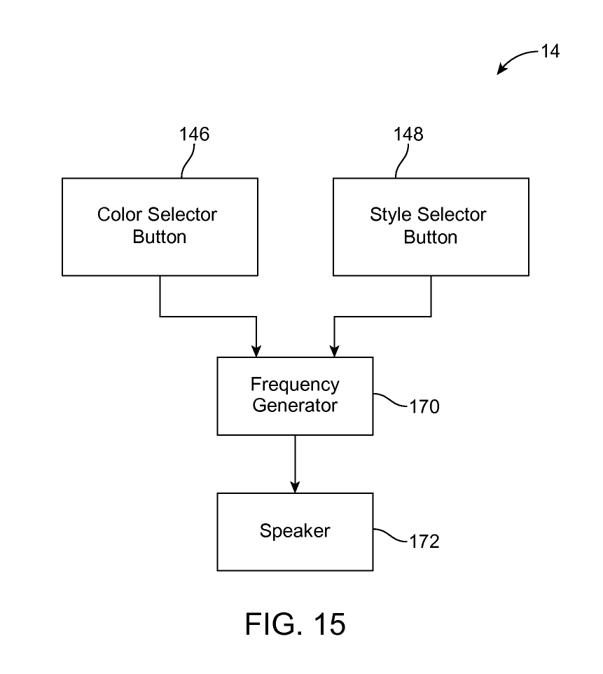

Referring to FIG. 15, with further reference to FIGS. 1, 9, and 12, the stylus 14 further comprises a frequency generator 170 internal to the body 140, and a speaker 172. The frequency generator 170 is configured to respond to actuation, i.e., pressing, of the buttons 146, 148 to cause the speaker 172 to produce and emit high-frequency signals, e.g., at or above about 18 KHz and preferably at or above human-audible frequencies, i.e., above 20 KHz. The frequency generator 170 is configured to cause the speaker 172 to produce/emit a different frequency depending upon which of the buttons 146, 148 is actuated. The stylus is thus configured to send wireless communication signals, e.g., to the device 12. The device 12 is configured to receive the signals produced by the frequency generator 170 and the speaker 172 and to respond to the signals by taking appropriate action.

The processor 20 is configured to respond to signals produced in response to actuation of the color selector button 146 to change a color shown on the display 16 corresponding to drawing on the display 16 using the stylus 14. For example, the processor 20 can respond to such signals by changing a color of lines displayed due to using the stylus while the device 12 is in the free-style drawing mode. Further, the processor 20 responds to signals from the speaker 172 due to the actuation of the style selector button 148 by changing a line style (e.g., line/stroke width and/or stroke edge smoothness) for strokes by the stylus. For example, the processor 20 may sequentially select from various line styles such as thin and straight (e.g., simulating a pen or pencil), medium straight (marker), wide straight (thicker marker), thin with rough edges (simulating a thin paintbrush), and wide with rough edges (thick paint brush). The processor 20 could also select as a style an eraser to remove, rather than add, lines or strokes on the display 16.

Further, the processor 20 is configured to provide feedback to the user regarding grip pressure. The processor 20 can respond to actuation (i.e., depression) of either of the buttons 146, 148 for an undesirable amount of time, e.g., meeting or exceeding a threshold amount of time, by displaying a warning on the display 16 or playing an audible warning message through the speaker 24 to induce or prompt the user to hold the implement less tightly.

Further Considerations

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, some configurations (including implementations) may employ a computer system to perform methods in accordance with various configurations of the invention. According to a set of configurations, some or all of the procedures of such methods are performed by the computer system in response to a processor executing one or more sequences of one or more instructions (which might be incorporated into the operating system of the computer system and/or other code, such as an application program) contained in working memory. Such instructions may be read into the working memory from another computer-readable medium, such as one or more storage device(s). Merely by way of example, execution of the sequences of instructions contained in the working memory might cause the processor(s) to perform one or more procedures of the methods described herein.

The terms “machine-readable storage medium,” “processor-readable storage medium,” and “computer-readable storage medium,” as used herein, refer to any medium that participates in providing data that causes a machine to operate in a specific fashion. Such a storage medium is a physical and/or tangible storage medium. Such a medium may take many forms, including but not limited to, non-volatile media, volatile media, and transmission media. Non-volatile media include, for example, optical and/or magnetic disks. Volatile media include, without limitation, dynamic memory. Transmission media include, without limitation, coaxial cables, copper wire and fiber optics.

Physical and/or tangible computer-readable storage media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable storage media may be involved in carrying one or more sequences of one or more instructions to a processor for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system. These signals, which might be in the form of electromagnetic signals, acoustic signals, optical signals and/or the like, are all examples of carrier waves on which instructions can be encoded, in accordance with various configurations of the invention.

The methods, systems, and devices discussed above are examples. Various alternative configurations may omit, substitute, or add various procedures or components as appropriate. For instance, in alternative methods, stages may be performed in orders different from the discussion above, and various stages may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable storage medium. Processors may perform the described tasks.

Elements discussed above may be components of a larger system, wherein rules may apply and/or take precedence over rules explicitly or implicitly discussed.

Still other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items prefaced by “at least one of” indicates a disjunctive list such that, for example, a list of “at least one of A, B, or C” includes A or B or C or AB or AC or BC or ABC (i.e., A and B and C), or combinations with more than one feature (e.g., AA, AAB, ABBC, etc.).

Further, more than one invention may be disclosed.

### EXAMPLES

Examples of implementations using the disclosure include the following.

1. A drawing guidance system comprising:
a touch-sensitive display configured to display images and to receive input by contact with the display;
a processing module communicatively coupled to the display and configured to:
cause the display to display to a user an object with initial visual stroke guidance information prompting the user to draw an initial stroke for drawing the object, the initial visual stroke guidance information including a starting location for an initial stroke and a direction indicator of the initial stroke from the starting location, the visual stroke guidance prompting the user to draw on the display at a present prompted location;
analyze data from the display regarding contact with the display by the user; and
in response to determining that the data indicate contact with the display by the user at the present prompted location, cause the display to provide visual feedback indicating progress in drawing the stroke and to change the present prompted location to a different location on the display.

2. The system of example 1 wherein the processing module is configured to cause the display to display a complete initial stroke line indicating the complete initial stroke, and to display only the initial stroke from among a plurality of strokes for completing the object.

3. The system of example 2 wherein the processing module is configured to cause the display to display a second stroke line for a second stroke for drawing the object only in response to determining that the data indicate successful complete drawing of the initial stroke.

4. The system of example 1 wherein the processing module is configured to cause the display to display the direction indicator in proximity to and pointing toward the present prompted location.

5. The system of example 1 further comprising a speaker communicatively coupled to the processing module, the processing module configured to cause the speaker to provide audible phonics information regarding the object.

6. The system of example 1 wherein the processing unit is configured to cause the display to display a set of objects, including the object, and an indication of successful completion of drawing for each of the objects.

7. The system of example 1 further comprising a stylus having a triangular cross-section and being configured to have a resistance when a tip of the stylus is moved across the display similar to a resistance of a pencil tip being moved across a sheet of paper.

8. The system of example 7 further comprising a receiver, wherein the stylus comprises:
a selector; and
a frequency generator coupled to the selector and configured to respond to actuation of the selector to emit a selector signal having a frequency above a human hearing range;
wherein the processing module is configured to respond to signals received from the receiver due to the selector signal to change at least one characteristic of a visual response on the display to contact by the stylus with the display.

9. The system of example 8 wherein the at least one characteristic is at least one of color, stroke width, and stroke edge smoothness.

What is claimed is:

1. A computer program product residing on a processor-readable storage medium and comprising processor-readable instructions configured to cause a processor to:
cause a display to display to a user an object with initial visual stroke guidance information prompting the user to draw an initial stroke for drawing the object, the initial visual stroke guidance information including an indication of a starting location for an initial stroke and an indication of a direction indicator of the initial stroke from the starting location, the visual stroke guidance being configured to prompt the user to draw on the display at a present prompted location;
analyze data from the display regarding contact with the display by the user; and
in response to determining that the data indicate contact with the display by the user at the present prompted location, cause the display to provide visual feedback indicating progress in drawing the stroke and to change the present prompted location to a different location on the display.

2. The computer program product of claim 1 wherein the instructions are further configured to cause the processor to cause the display to display a complete initial stroke line indicating the complete initial stroke, and initially to display only the initial stroke from among a plurality of strokes for completing the object.

3. The computer program product of claim 2 wherein the instructions are further configured to cause the processor to cause the display to display a second stroke line for a second stroke for drawing the object only in response to determining that the data indicate successful complete drawing of the initial stroke.

4. The computer program product of claim 1 wherein the instructions are configured to cause the processor to cause the display to display the direction indicator in proximity to and pointing toward the present prompted location.

5. The computer program product of claim 1 wherein the instructions are configured to cause the processor to cause the display to display a set of objects, including the object, and an indication of successful completion of drawing for each of the objects.

6. A stylus comprising:
a body comprising:
a proximal end;
a grasping portion extending distally from the proximal end, having a triangular cross-section, and comprising at least one first conductive portion; and
a distal end extending from the grasping portion and comprising a tip with a second conductive portion conductively coupled with the at least one first conductive portion of the grasping portion.

7. The stylus of claim 6 wherein the cross-section of the grasping portion has equal length sides of at least about 0.3 inches.

8. The stylus of claim 6 wherein the grasping portion is configured to provide visual indications of preferred locations for a user to grasp the stylus.

9. The stylus of claim 8 wherein the at least one first conductive portion comprises a plurality of first conductive portions that appear differently from other portions of the grasping portion.

10. The stylus of claim 9 wherein the plurality of first conductive portions have a different color than the other portions of the grasping portion.

11. The stylus of claim 6 wherein the tip is configured to interact with a touchscreen to simulate interaction of a pencil with paper.

12. The stylus of claim 6 wherein the tip is rounded and hollow, being configured to deform to provide a flat section of at least about 0.18 inches in diameter in response to being pressed against a flat surface with about 0.1 pounds of force.

13. The stylus of claim 6 further comprising:
a frequency generator;
a speaker communicatively coupled to the frequency generator; and
a selector coupled to the frequency generator;
wherein the frequency generator is configured to respond to actuation of the selector to cause the speaker to emit an audio signal with a frequency at or above about a human hearing range.

14. A system comprising:
a computer program product residing on a processor-readable storage medium and comprising processor-readable instructions configured to cause a processor to:
cause a display to display to a user an object with initial visual stroke guidance information prompting the user to draw an initial stroke for drawing the object, the initial visual stroke guidance information including a complete initial stroke line, an indicator of a starting location for the initial stroke and an indication of a direction of the initial stroke from the starting location, the visual stroke guidance being configured to prompt the user to draw on the display at a present prompted location;
analyze data from the display regarding contact with the display by the user;
in response to determining that the data indicate contact with the display by the user at the present prompted location, cause the display to provide visual feedback indicating progress in drawing the stroke and to change the present prompted location to a different location on the display; and
cause the display to display a second stroke line for a second stroke for drawing the object only in response to determining that the data indicate successful complete drawing of the initial stroke; and
a stylus comprising:
a proximal end;
a grasping portion extending distally from the proximal end, having a triangular cross-section, and comprising a plurality of first conductive portions having an appearance that is different from an appearance of other portions of the grasping portion; and
a distal end comprising a tip with a second conductive portion conductively coupled with the plurality of first conductive portions of the grasping portion.

15. The system of claim 14 wherein the stylus further comprises:
a frequency generator;
a speaker communicatively coupled to the frequency generator; and
a selector coupled to the frequency generator;
wherein the frequency generator is configured to respond to actuation of the selector to cause the speaker to emit an audio signal with a frequency at or above about a human hearing range; and
wherein the instructions are further configured to cause the processor to respond to signals received from a receiver in response to the audio signal to change at least one characteristic of a visual response on the display to contact by the stylus with the display.

16. The system of claim 15 wherein the at least one characteristic is at least one of color, stroke width, and stroke edge smoothness.
